(19) United States
(12) Patent Application Publication
(10) Pub. No.: US 2008/0048111 A1
(43) Pub. Date: Feb. 28, 2008

(54) Multiple Capture Device And Method

(76) Inventors: Paul C. Goodley, Cupertino, CA (US); Timothy Herbert Joyce, Mountain View, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/466,977

(22) Filed: Aug. 24, 2006

(51) Int. Cl. H01J 49/04

(52) U.S. Cl. 250/288

(57) ABSTRACT

The invention provides a mass spectrometry system including an ion source for providing an ion spray, an ion capture device adjacent to the ion source, the ion capture device having a housing having a wall and chamber. The wall having a first aperture and a second aperture spaced from the first aperture, the first and second apertures designed for receiving an ion from the ion spray; a vacuum source in connection with the ion source for providing gas flow for entraining and directing ions that are captured by the ion capture device, wherein when the ion source is positioned adjacent to the ion capture device, the ions are captured by the first and second apertures and directed into the chamber of the housing; and a detector downstream from the ion capture device for detecting ions captured by the ion capture device.

The invention also provides an ion source for providing an ion spray, an ion capture device adjacent to said ion source, the ion capture device having a wall and chamber, the wall having a first aperture and a second aperture spaced from the first aperture, the first and second apertures designed for receiving an ion from the ion spray; a vacuum source in connection with the ion source for providing gas flow for entraining and directing ions that are captured by the ion capture device, wherein when the ion source is positioned adjacent to the ion capture device, the ions are captured by the first and second apertures and directed into the chamber of the housing.

Methods of ion capturing and collection using the devices and system are also disclosed.

### BACKGROUND

Various mass spectrometry devices and systems have been developed for analyzing samples at small volume and low flow rates. Nanospray and picospray technology are techniques that have gained popular acceptance. For instance, typical low flow ion sources operate at flow rates from about 0.001×10⁻⁹ to 5000×10⁻⁹ L/Min and require sample sizes in the 10⁻²¹ to 10⁻¹⁴ molar range. The problem with many of these devices and systems is that they use low flow rates and they often lose their sensitivity as the volume or amount of analyte is lowered. In addition, with many of the low flow devices there are problems with sample loss or poor ion collection. This effects the overall final detection and sensitivity of the instrument system.

A number of different structural devices have been designed for collecting ions. Some of these collection devices include and are not limited to ion traps, field regions, electrodes, various surfaces, capillaries, ion pipes, conduits, chambers etc. Some of the structural devices have focused strictly on changes or alterations in the capillary design. A number of recent advances have focused on structurally altering the collection devices to more efficiently capture or collect ions. Most of these designs have been limited to matrix assisted laser desorption ionization (MALDI) and atmospheric pressure matrix assisted laser desorption ionization (AP-MALDI) techniques where an ion plume is created.

There is a need, therefore, to provide a simple structure and methods for capturing and collecting ions more efficiently in devices with low flow rates and sample. In addition, it is also desirable to be able to more efficiently collect ions so that overall sensitivity levels are improved. These and other limitations of the art are addressed by the present invention.

### SUMMARY OF THE INVENTION

The invention provides a mass spectrometry system, comprising an ion source for providing an ion spray; an ion capture device adjacent to said ion source, said ion capture device having a housing with a wall and chamber, said wall having a first aperture and a second aperture spaced from the first aperture, said first and second apertures designed for receiving ions from said ion spray; a vacuum source in connection with said ion source for providing gas flow for entraining and directing ions that are captured by the ion capture device wherein when said ion source is positioned adjacent to said ion capture device, said ions are captured by said first and second apertures and directed into said chamber of said housing; and a detector downstream from said ion capture device for detecting ions captured by said ion capture device.

The invention also provides an ion capture device for use in an ion source to capture ions from an ion spray, comprising a housing having a wall and a chamber, said wall having a first aperture and a second aperture spaced from the first aperture, said first and second apertures designed for receiving ions from said ion spray, wherein when said ion spray is directed adjacent to said ion capture device, said ions are captured by said first and second apertures and directed into said chamber of said housing.

The invention also provides a method for capturing ions from a nanospray or picospray ion source, comprising providing a source of ions; spraying the ions from a nanospray ion source; and capturing the ions from the nanospray or picospray ion source using a housing having more than one aperture for ion collection.

### BRIEF DESCRIPTION OF THE FIGURES

The invention is described in detail below with reference to the following figures:

FIG. 1 shows a general block diagram of the present invention.

FIG. 2 shows a perspective view of the present invention.

FIG. 3 shows a cross-sectional view of a first embodiment of the present invention.

FIG. 4A shows an alternate embodiment of a capillary of the present invention.

FIG. 4B shows an alternate embodiment of a capillary of the present invention.

FIG. 4C shows an alternate embodiment of a capillary of the present invention.

FIG. 5 shows a second embodiment of the present invention.

### DETAILED DESCRIPTION OF THE INVENTION

Before describing the invention in detail, it must be noted that, as used in his specification and the appended claims, the singular forms “a,” “an,” and “the” include plural referents unless the context clearly dictates otherwise. Thus, for example, reference to “a housing” may include more than one “housing”. Reference to “an ion capture device” may include more than one “ion capture device”.

In describing and claiming the present invention, the following terminology will be used in accordance with the definitions set out below.

The term “adjacent” means near, next to, or adjoining.

The term “capillary” refers to a conduit, tube, pipe or similar type structure that may be used to collect ions. The structure may comprise any number of shapes and sizes and diameters. For instance, in certain embodiments the capillary tip may be altered to more easily collect ions. Capillary tips may for instance include and not be limited to conical shapes, designs that taper from wide to narrow in diameter, funnel shapes or any similar type shape or design that may more easily collect ions and direct them toward a common direction or space. As mentioned, in other embodiment the capillary itself may be modified to collect ions. It may comprise a circular shape, a conical shape, a funnel shape, or taper from wide to narrow in diameter. Other embodiments may also be possible.

The term “ion capture device” refers to any device that may be used for collecting ions. The device may comprise any number of shapes or sizes. For instance, an ion capture device may comprise a housing with a wall and chamber and have one or more apertures for collecting ions. The shape of the device may be conical, rectangular, round, funnel shaped or taper from wide to narrow in diameter. Other shapes, sizes and designs may also be possible.

The term “ion source” may comprise standard ion sources know in the art. The term should also be interpreted broadly to comprise any simple device that produces or generates ions. In particular, the term refers to ion sources that provide ions in a spray or plume that may be collected or directed.

The term “nanospray” refers low flow ion sources that operate at low flow rates from about 0.001×10⁻⁹ to 5000×10⁻⁹ L/Min and require sample sizes in the 10⁻²¹ to 10⁻¹⁴ molar range. This may also include flow rates and sample sizes used for picospray devices and sources.

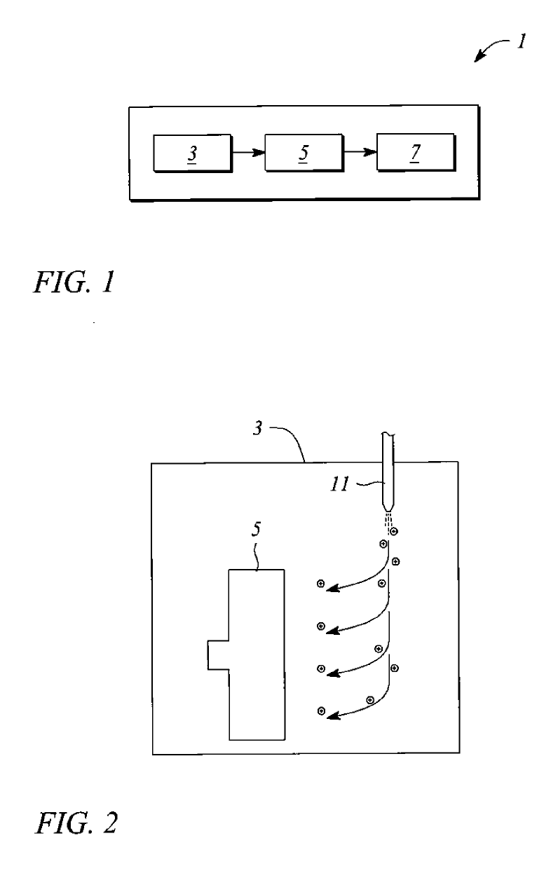

FIG. 1 shows a general block diagram of the present invention. The mass spectrometry system 1 of the present invention comprises an ion source 3, an ion capture device 5, and a detector 7. The ion capture device 5 is disposed adjacent to the ion source 3. In certain embodiments of the invention the ion source 3 may be integrated with the ion capture device 5. In other embodiments, the ion capture device 5 may also be disposed in the ion source 3. This is not a requirement of the invention and should not be interpreted to limit the invention in any way.

The ion source 3 of the present invention may comprise any ion source known in the art for producing ions. Typical ion sources for nanospray/picospray devices comprise an electrospray ion source (ESI). The invention has particular benefit and applicability to ion sources that spray, plume or eject ions. Although it is within the spirit of the invention that other ion sources may also be employed. For instance, other ions sources such at atmospheric pressure photo ionization (APPI) ion sources may be used, atmospheric pressure matrix assisted laser desorption ionization (AP-MALDI) ion sources and matrix assisted laser desorption ionization (MALDI) ion sources may be used. In addition, chemical ionization (CI) ion sources may be used or other types of sources that eject ions as large volume, high rates etc.

FIG. 2 shows a general perspective view of the present invention. The diagram is not to scale and in certain instances features of the invention may have been exaggerated to clarify parts of the invention. FIG. 2 shows a general embodiment of the ion capture device disposed in the ion source 3. The ion capture device 5 is also adjacent to a nebulizer tip 11. The nebulizer tip 11 provides an ion spray or plume as shown in the diagram.

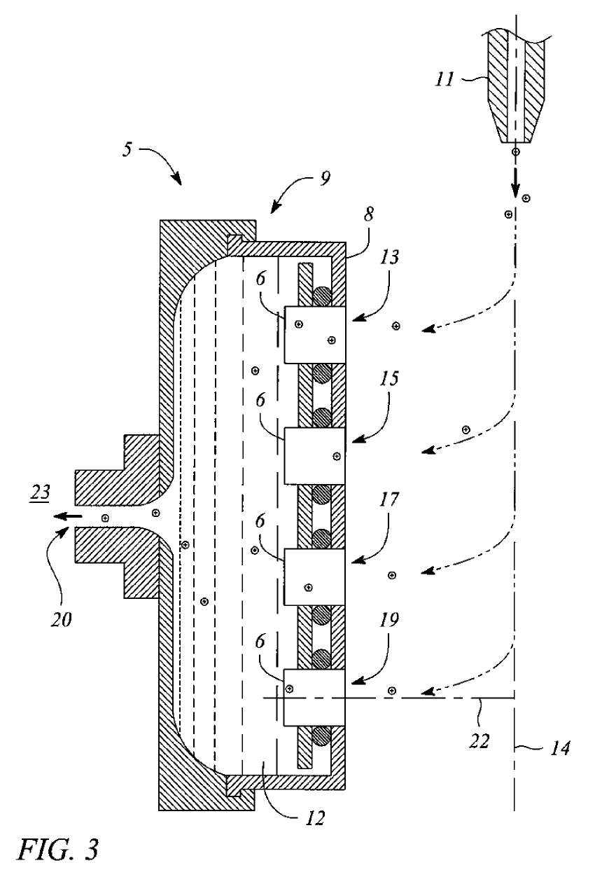

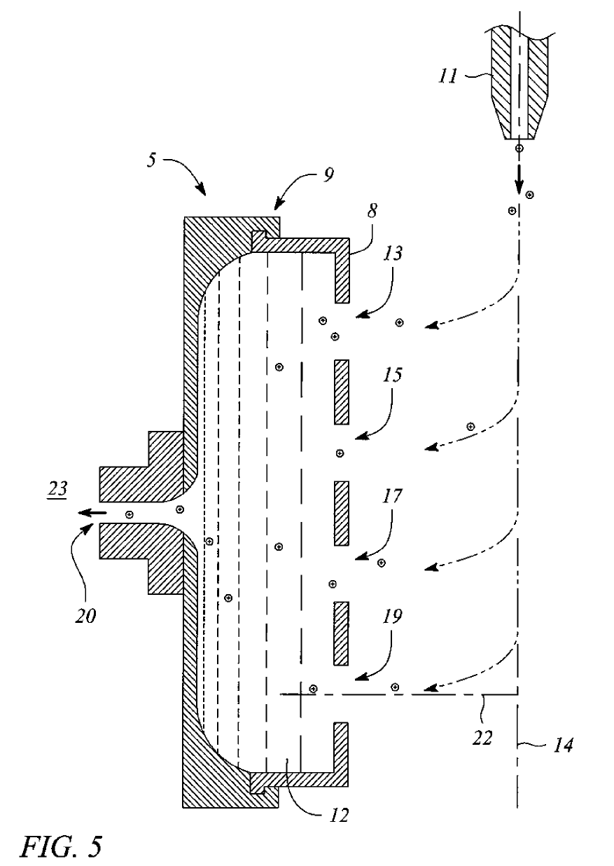

FIGS. 3 and 5 show various embodiments of the ion capture device 5. The ion capture device 5 comprises a housing 9 having a wall 8 and a chamber 12. Typically, the housing 9 may have one or more apertures designed for receiving ions. For instance, in FIGS. 3 and 5, the housing 9 comprises a first aperture 13, a second aperture 15, a third aperture 17 and a fourth aperture 19. The first aperture 13 is spaced from the second aperture 15. Other combinations, designs sizes and orientations of the apertures are possible. In addition, in certain embodiments, the apertures may be designed or extended to define capillaries 6. The apertures may be designed in any number of shapes, sizes and diameters. They need not be similar to each other. In each case, the apertures all lead into the common chamber 12. The chamber 12 may be designed in any number of shapes, sizes and designs for receiving, entraining and transporting ions. Other chambers may also be employed or combination of chambers.

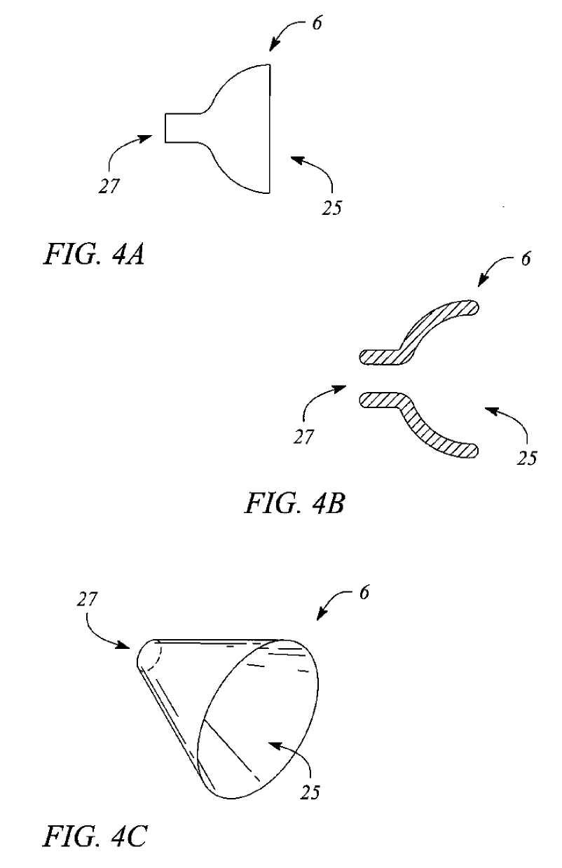

Referring to FIG. 3, the ion capture device 5 is positioned adjacent to a nebulizer tip 11 which releases, plumes or sprays ions along a concentrated ion path called a molecular axis 14. It should be noted that the apertures 13-19 of the ion capture device 3 each have a central axis 22 that may be generally orthogonal to the molecular axis 14 of the ion path. Other angles and directions of orientation may be possible. For instance, the central axis 22 of one or more of the apertures may define an angle with the molecular axis 14 of the ion path. The angle may be from about 0 to 120 degrees. In certain embodiments it may be from 20 to about 90 degrees. Each of the apertures 13-19 feed into the housing chamber 12 which connects with a common collection channel 20. Other embodiments or designs may also be employed with the present invention. In addition, it is within the scope of the invention that other apertures or a plurality of apertures are possible in the wall 8 of the housing 9. As discussed these apertures may also comprise a capillary. Capillaries may generally comprise and not be limited to a portion of a conduit, pipe, tube or similar type devices. In still other embodiments a capillary may be positioned in or around the aperture. The capillary may comprise an end portion 25 and a body portion 27. The end portion 25 having a slightly larger diameter than the body portion diameter (See FIG. 4)

FIGS. 4A-4C show various embodiments of capillaries or portions of capillaries that may be used with the present invention (note: these devices can be used as the capillary itself or on the end of the capillary for collecting ions). These capillaries can be used in place of or in conjunction with a conduit for collection of ions. One or more of these capillaries may be employed.

FIG. 5 shows still another embodiment in which the ion capture device 3 has been structurally designed or altered at the point of ion collection. It should be noted that in this embodiment of the invention no conduit is employed. One or more apertures may be employed that are designed directly in wall 8.

After the ions have been captured by the ion capture device 5, they are then directed to the detector 7. The detector 7 may comprise any number of detectors know in the art for detecting and/or characterizing and quantifying ions. For instance, the detector 7 may comprise a time of flight, photo or cathode device etc. Other devices known in the art may be employed with the present invention.

Having discussed the apparatus of the invention, a description of the method of the invention is now in order. The method of capturing ions from a nanospray or picospray ion source comprises providing a source of ions; spraying the ions from a nanospray or picospray ion source; and capturing the ions from the nanospray or picospray ions source using a housing having one or more apertures for ion collection.

The method of the invention begins with the production of ions. The ion source 3 provides a source of ions that are sprayed or plumed adjacent to the ion capture device 5. As discussed, this may be accomplished using any number of ion sources. The invention has particular applicability with ion sources that spray or disperse ions at low flow rates. After the ions have been sprayed or plumed from the ion source 3 they are then captured by the ion capture device 5. The ions are captured by the ion capture device 5 as they pass by the device (See FIGS. 2-3). Generally speaking the ions may be directed into each of the apertures 13-19 as they pass by. This is caused by the gas flow or vacuum provided through common collection conduit 20 and chamber 12. The vacuum may be created by a vacuum source 22 (See FIGS. 3 and 5). The ions are directed into each aperture and become entrained by any excess carrier or source gas and remain mobile. Theoretically, a portion of the ions collide with the walls and form a protective monolayer of charged species. Since many of the ions are the same charge at the monolayer, this allows for the entrainment and movement of later collected ions. The device has the capability of collecting more ions to improve overall instrument sensitivity. In addition, based on the design there is less possibility of contamination with analyte that is mixed with ions of interest. Excess analyte and solvent droplets by pass the inlets of the ion capture device 5 and, are eliminated. Larger droplets provide background interference or noise to an instrument. The captured ions are ten sent to the detector 7 where they are characterized and/or quantified and then output as a result on a computer screen or similar type of device.

We claim:

1. An ion capture device for capturing ions from an ion spray, comprising:
(a) a housing having a wall and a chamber,
said wall having a first aperture and a second aperture spaced from the first aperture, said first and second apertures designed for receiving ions from said ion spray,
wherein when said ion spray is directed adjacent to said ion capture device, said ions are captured by said first and second apertures and directed into said chamber of said housing.

2. An ion capture device as recited in claim 1, wherein said first aperture comprises a longitudinal axis and said ion spray from said ion source comprises a molecular axis and wherein said longitudinal axis of said first aperture is positioned relative to said molecular axis of said ion spray to define an angle.

3. An ion capture device, as recited in claim 2, wherein said angle is from between about 20 degrees to about 90 degrees.

4. An ion capture device as recited in claim 1, wherein said housing wall comprises a plurality of apertures for capturing ions from an ion spray.

5. An ion capture device as recited in claim 1, wherein the housing wall defines a capillary for collecting ions.

6. An ion capture device as recited in claim 1, further comprising a capillary disposed in the housing wall for collecting ions.

7. An ion source as recited in claim 6, wherein the capillary further comprises a body portion and an end portion wherein the end portion has a diameter larger than the diameter of the body portion.

8. A mass spectrometry system, comprising:
(a) an ion source for providing an ion spray;
(b) an ion capture device adjacent to said ion source, said ion capture device including a housing having a wall and chamber, said wall having a first aperture and a second aperture spaced from the first aperture, said first and second apertures designed for receiving ions from said ion spray,
wherein when said ion source is positioned adjacent to said ion capture device, said ions are captured by said first and second apertures and directed into said chamber of said housing; and
(c) a detector downstream from said ion capture device for detecting ions captured by said ion capture device.

9. A mass spectrometry system as recited in claim 8, wherein said first aperture of said housing comprises a longitudinal axis and said ion spray from said ion source comprises a molecular axis and wherein said longitudinal axis of said first aperture is positioned relative to said molecular axis of said ion spray to define an angle.

10. A mass spectrometry system as recited in claim 9, wherein said angle is from between about 20 degrees to about 90 degrees.

11. A mass spectrometry system as recited in claim 8, wherein said housing wall comprises a plurality of apertures for capturing ions from said ion spray.

12. An ion capture device for use in a nanospray ion source to capture ions from an ion spray, comprising:
(a) a housing having a wall and a chamber,
said wall having a first aperture and a second aperture spaced from the first aperture, said first and second apertures designed for receiving ions from said nanospray ion spray; and
(b) a vacuum source in connection with said housing;
wherein when said ion spray is directed adjacent to said ion capture device, and said ions are captured by said first and second apertures and directed into said chamber of said housing.

13. An ion capture device as recited in claim 12, wherein said first aperture comprises a longitudinal axis and said ion spray from said ion source comprises a molecular axis and wherein said longitudinal axis of said first aperture is positioned relative to said molecular axis of said ion spray to define an angle.

14. An ion capture device, as recited in claim 13, wherein said angle is from between about 20 degrees to about 120 degrees.

15. An ion capture device as recited in claim 12, wherein said housing wall comprises a plurality of apertures for capturing ions from an ion spray.

16. A mass spectrometry system, comprising:
(a) an ion source for providing an ion spray;
(b) an ion capture device adjacent to said ion source, said ion capture device having a wall and chamber, said wall having a first aperture and a second aperture spaced from the first aperture, said first and second apertures designed for receiving an ion from said ion spray,
(c) a vacuum source in connection with said ion source for providing gas flow for entraining and directing ions that are captured by the ion capture device;
wherein when said ion source is positioned adjacent to said ion capture device, said ions are captured by said first and second apertures and directed into said chamber of said housing; and
(d) a detector downstream from said ion capture device for detecting ions captured by said ion capture device.

17. A mass spectrometry system as recited in claim 16, wherein said first aperture comprises a longitudinal axis and said ion spray from said ion source comprises a molecular axis and wherein said longitudinal axis of said first aperture is positioned relative to said molecular axis of said ion spray to define an angle.

18. A mass spectrometry system, as recited in claim 17, wherein said angle is from between about 60 degrees to about 90 degrees.

19. An ion source for providing an ion spray, comprising:
(a) an ion capture device adjacent to said ion source, said ion capture device having a wall and chamber, said wall having a first aperture and a second aperture spaced from the first aperture, said first and second apertures designed for receiving an ion from said ion spray.

20. An ion source as recited in claim 19, wherein said first aperture comprises a longitudinal axis and said ion spray from said ion source comprises a molecular axis and wherein said longitudinal axis of said first aperture is positioned relative to said molecular axis of said ion spray to define an angle.

21. An ion source, as recited in claim 20, wherein said angle is from between about 60 degrees to about 90 degrees.

22. An ion source as recited in claim 21, wherein said housing wall comprises a plurality of apertures for capturing ions from said ion spray.

23. A nanospray ion capture device for capturing ions from an ion source, comprising:
(a) a housing having a wall and a chamber,
said wall having a plurality of apertures designed for receiving ions from the nanospray ion source; and
(b) a vacuum source in connection with said ion source for providing gas flow for entraining and directing ions that are captured by the ion capture device;
wherein when said ion source is positioned adjacent to said ion capture device, said ions are captured by said first and second apertures and directed into said chamber of said housing.

24. A nanospray ion capture device as recited in claim 23, wherein said first aperture comprises a longitudinal axis and said ion spray from said ion source comprises a molecular axis and wherein said longitudinal axis of said first aperture is positioned relative to said molecular axis of said ion spray to define an angle.

25. A nanospray ion capture device, as recited in claim 24, wherein said angle is from between about 60 degrees to about 90 degrees.

26. A method of capturing ions from a nanospray ion source, comprising:
(a) providing a source of ions;
(b) spraying the ions from a nanospray ion source; and
(c) capturing the ions from the nanospray ions source using a housing having more than one aperture for ion collection.
